(19) United States
(12) Patent Application Publication
(10) Pub. No.: US 2024/0095052 A1
(43) Pub. Date: Mar. 21, 2024

(54) Machine Learning with Dynamic Bytecode Transformation

(71) Applicant: Meta Platforms, Inc., Menlo Park, CA (US)

(72) Inventor: Jason Ansel, Mountain View, CA (US)

(21) Appl. No.: 17/947,004

(22) Filed: Sep. 16, 2022

(51) Int. Cl. G06F 9/455; G06F 8/41

(52) U.S. Cl. CPC G06F 9/4552; G06F 8/443

(57) ABSTRACT

In one embodiment, a computing system may receive, by a just-in-time compiler, a plurality of bytecode to dynamically modify prior to executing. The computing system may extract, using the just-in-time compiler, sequences of one or more operations from the plurality of bytecode. The computing system may generate, using the just-in-time compiler an FX graph based on the sequences of the one or more operations. The computing system may compile, using a user-defined compiler, the FX graph into a compiled function. The computing system may execute the plurality of bytecode based at least on the compiled function.

### TECHNICAL FIELD

This disclosure generally relates to machine learning techniques.

### BACKGROUND

Bytecode is computer object code that an interpreter converts into binary machine code so it can be read by a computer's hardware processor. The interpreter is typically implemented as a virtual machine (VM) that translates the bytecode for the target platform. The machine code consists of a set of instructions that the processor understands. With bytecode, the source code must be compiled only once. The platform-specific interpreter then converts it to machine code that can be executed by the OS and central processing unit, or CPU. Bytecode eliminates the need to recompile source code for each target platform. Although the interpreters differ between platforms, the application's bytecode does not. This approach lets each system interpret the same bytecode files. The bytecode itself is in a binary format that consists of constants, references and numeric codes.

### SUMMARY OF PARTICULAR EMBODIMENTS

In particular embodiments, a computing system may use a just-in-time compiler to dynamically modify Python bytecode before it is executed. While this disclosure generally describes processes using Python bytecode, this disclosure contemplates similar processes using other bytecodes. In machine-learning frameworks there has been a tension between graph mode frameworks (that are fast but harder to use) and eager-mode frameworks (that excel in usability but sometimes are slower). That is, there has been a desire to find a balance of graph mode frameworks and eager-mode frameworks for machine-learning frameworks so the machine-learning framework may operate fast and is usable. To achieve a balance of a fast and usable framework, a just-in-time compiler may be implemented to modify the framework to dynamically modify bytecode. As an example and not by way of limitation, a just-in-time compiler, TorchDynamo, may be used to dynamically modify Python bytecode.

In particular embodiments, TorchDynamo may be a Python-level just-in-time compiler that is designed to make unmodified PyTorch programs faster by modifying the Python bytecode before the bytecode is executed. While this disclosure generally describes TorchDynamo being used to dynamically modify Python bytecode, this disclosure contemplates another just-in-time compiler that can modify other bytecodes. TorchDynamo may dynamically rewrite Python bytecode in order to extract sequences of PyTorch operations into an FX Graph which is then just-in-time compiled with a user-defined compiler. The FX Graph may be created through bytecode analysis, which may be designed to generate smaller graph fragments that can be mixed with Python execution. This approach of using TorchDynamo may have advantages that include TorchDynamo being able to support all Python because TorchDynamo may fallback to running the original bytecode, TorchDynamo may have low overhead where it is possible to remove Python overheads from the original program by intercepting things at the top of the stack, and TorchDynamo does not introduce any added latency by deferring execution.

In particular embodiments, TorchDynamo may be introduced into the frame evaluation API in CPython. TorchDynamo may install a custom eval frame function which performs dynamic bytecode analysis and transformation. The transformations may insert calls to compiled FX Graphs into the bytecode. TorchDynamo may protect the reuse of the compiled artifacts by guards to ensure soundness. Failure of the guards may trigger re-analysis and transformation of the bytecode. TorchDynamo may find opportunities for optimization by transforming the Python bytecode. If TorchDynamo encounters calls to non-PyTorch things or unrecognizable Python structures, TorchDynamo may leave those calls in the original bytecode.

In particular embodiments, during runtime, TorchDynamo may create FX Graphs that may be hashed into graph keys. If the graph key of a hashed FX Graph is not in a subgraph database, the graph key may be added to the subgraph database and the FX Graph may be run eagerly. If the graph key is in the subgraph database and has been optimized, the backend and schedule stored in the subgraph database may be used. In particular embodiments, TorchDynamo may iterate through the subgraph database and optimize the graphs found there.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example process of converting an object to bytecode, in accordance with particular embodiments.

FIG. 2 illustrates another example process of converting an object to bytecode, in accordance with particular embodiments.

FIG. 3 illustrates example code, in accordance with particular embodiments.

FIG. 4 illustrates example bytecode, in accordance with particular embodiments.

FIG. 5 illustrates another example bytecode, in accordance with particular embodiments.

FIG. 6 illustrates example compiled graphs, in accordance with particular embodiments.

FIG. 7 illustrates an example process of a just-in-time compiler operating during runtime, in accordance with particular embodiments.

FIG. 8 illustrates an example method of converting an object to bytecode, in accordance with particular embodiments.

FIG. 9 illustrates an example network environment associated with a VR or social-networking system.

FIG. 10 illustrates an example artificial neural network.

FIG. 11 illustrates an example computer system.

### DESCRIPTION OF EXAMPLE EMBODIMENTS

In particular embodiments, a computing system may use a just-in-time compiler to dynamically modify Python bytecode before it is executed. While this disclosure generally describes processes using Python bytecode, this disclosure contemplates similar processes using other bytecodes. In machine-learning frameworks there has been a tension between graph mode frameworks (that are fast but harder to use) and eager-mode frameworks (that excel in usability but sometimes are slower). That is, there has been a desire to find a balance of graph mode frameworks and eager-mode frameworks for machine-learning frameworks so the machine-learning framework may operate fast and is usable. To achieve a balance of a fast and usable framework, a just-in-time compiler may be implemented to modify the framework to dynamically modify bytecode. As an example and not by way of limitation, a just-in-time compiler, TorchDynamo, may be used to dynamically modify Python bytecode.

In particular embodiments, TorchDynamo may be a Python-level just-in-time compiler that is designed to make unmodified PyTorch programs faster by modifying the Python bytecode before the bytecode is executed. While this disclosure generally describes TorchDynamo being used to dynamically modify Python bytecode, this disclosure contemplates another just-in-time compiler that can modify other bytecodes. TorchDynamo may dynamically rewrite Python bytecode in order to extract sequences of PyTorch operations into an FX Graph which is then just-in-time compiled with a user-defined compiler. The FX Graph may be created through bytecode analysis, which may be designed to generate smaller graph fragments that can be mixed with Python execution. This approach of using TorchDynamo may have advantages that include TorchDynamo being able to support all Python because TorchDynamo may fallback to running the original bytecode, TorchDynamo may have low overhead where it is possible to remove Python overheads from the original program by intercepting things at the top of the stack, and TorchDynamo does not introduce any added latency by deferring execution.

In particular embodiments, TorchDynamo may be introduced into the frame evaluation API in CPython. TorchDynamo may install a custom eval frame function which performs dynamic bytecode analysis and transformation. The transformations may insert calls to compiled FX Graphs into the bytecode. TorchDynamo may protect the reuse of the compiled artifacts by guards to ensure soundness. Failure of the guards may trigger re-analysis and transformation of the bytecode. TorchDynamo may find opportunities for optimization by transforming the Python bytecode. If TorchDynamo encounters calls to non-PyTorch things or unrecognizable Python structures, TorchDynamo may leave those calls in the original bytecode.

In particular embodiments, during runtime, TorchDynamo may create FX Graphs that may be hashed into graph keys. If the graph key of a hashed FX Graph is not in a subgraph database, the graph key may be added to the subgraph database and the FX Graph may be run eagerly. If the graph key is in the subgraph database and has been optimized, the backend and schedule stored in the subgraph database may be used. In particular embodiments, TorchDynamo may iterate through the subgraph database and optimize the graphs found there.

In particular embodiments, a computing system may use just-in-time compiler to perform the processes described herein. In particular embodiments, the computing system may receive a plurality of bytecode to dynamically modify prior to executing. As an example and not by way of limitation, the computing system may access code in Python to dynamically modify prior to executing. In particular embodiments, the computing system may use a just-in-time compiler to receive the plurality of bytecode to dynamically modify prior to executing. As an example and not by way of limitation, the computing system may use TorchDynamo to receive a plurality of bytecode to dynamically modify the plurality of bytecode prior to executing. Although this disclosure describes receiving a plurality of bytecode in a particular manner, this disclosure contemplates receiving a plurality of bytecode in any suitable manner.

In particular embodiments, a computing system may extract sequences of one or more operations from the plurality of bytecode. In particular embodiments, the computing system may use a just-in-time compiler to extract sequences of one or more operations from the plurality of bytecode. As an example and not by way of limitation, the computing system may use TorchDynamo to extract PyTorch operations from the bytecode. Although this disclosure describes extracting sequences of one or more operations in a particular manner, this disclosure contemplates extracting sequences of one or more operations in any suitable manner.

In particular embodiments, a computing system may generate an FX graph based on the sequences of the one or more operations. In particular embodiments, a computing system may use a just-in-time compiler to generate an FX graph based on the sequences of the one or more operations. As an example and not by way of limitation, the computing system may use TorchDynamo to extract one or more sequences of PyTorch operations into an FX graph. In particular embodiments, the just-in-time compiler may analyze the plurality of bytecode. In particular embodiments, the just-in-time compiler may generate one or more small graph fragments to generate the FX graph. Although this disclosure describes generating an FX graph in a particular manner, this disclosure contemplates generating an FX graph in any suitable manner.

In particular embodiments, the computing system may use a user-defined compiler on the FX graph to generate a compiled function. In particular embodiments, the computing system may compile the FX graph into a compiled function using a user-defined compiler. In particular embodiments, the computing system may insert one or more calls to the FX graph or the compiled function into the plurality of bytecode to be executed. Although this disclosure describes generating a compiled function in a particular manner, this disclosure contemplates generating a compiled function in any suitable manner.

In particular embodiments, the computing system may execute the plurality of bytecode based at least on the compiled function. In particular embodiments, the computing system may identify one or more calls to an unrecognizable structure from the plurality of bytecode. The computing system may use a just-in-time compiler to identify the one or more calls to the unrecognizable structure from the plurality of bytecode. In particular embodiments, executing the plurality of bytecode comprises at least executing the identified one or more calls. In particular embodiments, the computing system may use the just-in-time compiler to generate one or more guards for the plurality of bytecode. In particular embodiments, the computing system may identify a failure of the one or more guards for the plurality of bytecode. The computing system may use the just-in-time compiler to identify the failure of the one or more guards for the plurality of bytecode. In particular embodiments, the computing system may trigger an analysis of the plurality of bytecode in response to the failure of the one or more guards. The computing system may use the just-in-time compiler to trigger the analysis of the plurality of bytecode. In particular embodiments, the computing system may hash the FX graph into a graph key. The computing system may access a subgraph database comprising a plurality of graph keys, a plurality of backends, and a plurality of schedules. The plurality of graph keys stored in the subgraph database may be matched to one or more respective backends and schedules. In particular embodiments, the computing system may determine whether the graph key matches one of the plurality of graph keys. In particular embodiments, the computing system may, responsive to determining the graph key does not match one of the plurality of graph keys, add the graph key to the subgraph database. The computing system may run the graph key eagerly to execute the plurality of bytecode. In particular embodiments, the computing system may, responsive to determining the graph key matches one of the plurality of graph keys, identify a respective backend of the plurality of backends corresponding to the graph key and a respective schedule of the plurality of schedules corresponding to the graph key. The computing system may execute the plurality of bytecode by using the respective backend and the respective schedule. Although this disclosure describes executing a plurality of bytecode in a particular manner, this disclosure contemplates executing a plurality of bytecode in any suitable manner.

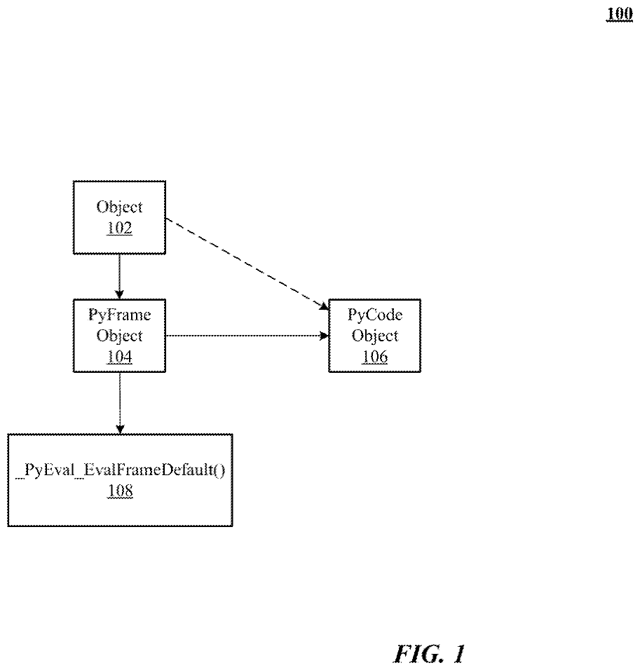

FIG. 1 illustrates an example process 100 of converting an object 102 to bytecode. In particular embodiments, the object 102 may be embodied as a file containing code. The code may be converted to bytecode. In particular embodiments, the object 102 may be translated into bytecode during the process 100. In particular embodiments, the object 102 may be translated to a PyFrame object 104 and a PyCode object 106. The PyFrame Object 104 may reference the PyCode Object 106. While this disclosure describes the process 100 with respect to translating an object 102 to PyFrame Object 104 and PyCode Object 106, this disclosure contemplates translating the object 102 to other objects. In particular embodiments, PyCode Object 106 may be embodied as bytecode. The results of the translation may be sent to an interpreter 108. As an example and not by way of limitation, the interpreter 108 may be embodied as _PyEval_EvalFrameDefault( ) 108. In particular embodiments, the interpreter 108 may interpret the PyFrame Object 104 and PyCode Object 106 to execute the object 102.

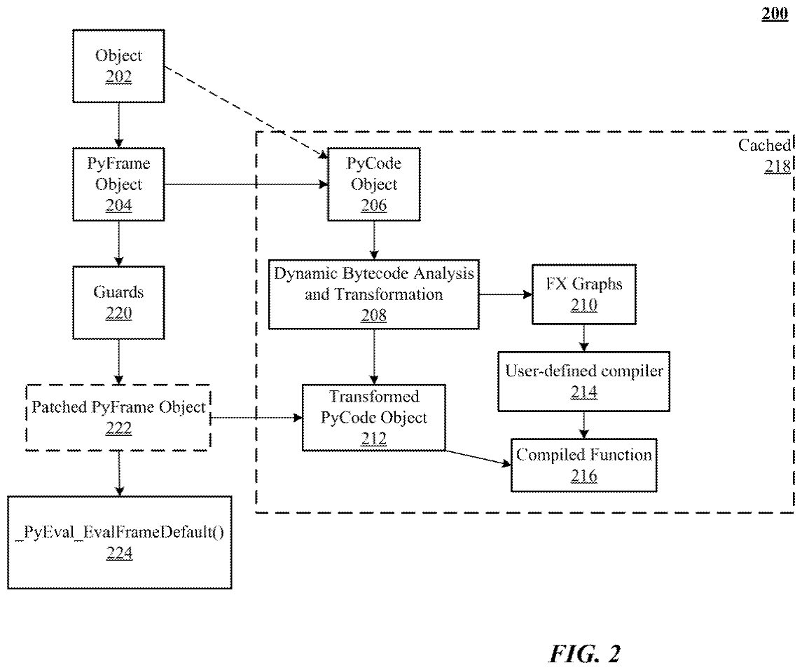

FIG. 2 illustrates another example process 200 of converting an object 202 to bytecode. In particular embodiments, the object 202 may be embodied as a file containing code. The code may be converted to bytecode. In particular embodiments, the object 202 may be translated into bytecode during the process 200. In particular embodiments, the object 202 may be translated to a PyFrame object 204 and a PyCode object 206. The PyFrame Object 204 may reference the PyCode Object 206. While this disclosure describes the process 200 with respect to translating an object 202 to PyFrame Object 204 and PyCode Object 206, this disclosure contemplates translating the object 202 to other objects. In particular embodiments, PyCode Object 206 may be embodied as bytecode. In particular embodiments, a dynamic bytecode analysis and transformation process 208 may be performed on the PyCode Object 206. In particular embodiments, the dynamic analysis and transformation process 208 may be performed by a just-in-time compiler. As an example and not by way of limitation, the process 208 may be performed by TorchDynamo which may be configured to perform analysis on bytecode to modify the bytecode prior to executing the bytecode. In particular embodiments, the just-in-time compiler may extract one or more operations from PyCode Object 206 to generate one or more FX Graphs 210. In particular embodiments, the one or more FX Graphs 210 may be just-in-time compiled using a user-defined compiler 214 to generate a compiled function 216. The user-defined compiler 214 may be selected by the user to compile the one or more FX graphs 210 into a compiled function 216. In particular embodiments, the just-in-time compiler may generate a transformed PyCode Object 212 which may reference the compiled function 216. In particular embodiments, the process of analyzing the the PyCode Object 206 to generate a transformed PyCode Object 212 may be cached 218. In particular embodiments, the PyCode Object 206, dynamic bytecode analysis and transformation 208, FX Graphs 210, transformed PyCode Object 212, user-defined compiler 214, and compiled function 216 may be cached 218. In particular embodiments, the PyFrame Object 204 may be configured with guards 220. In particular embodiments, a just-in-time compiler may generate guards 220. In particular embodiments, the guards 220 may be used to trigger re-analysis and transformation if the guards 220 fail. As an example and not by way of limitation, a just-in-time compiler may specify local arg “a” must be a torch.Tensor and local arg “b” must be a torch.Tensor. The just-in-time compiler may generate a new Patched PyFrame Object 222 with the additions of the guards to the PyFrame Object 204. In particular embodiments, the new Patched PyFrame Object 222 may reference the transformed PyCode Object 212. In particular embodiments, the Patched PyFrame Object 222 may be sent to an interpreter 224 what may be used to interpret the Patched PyFrame Object 222.

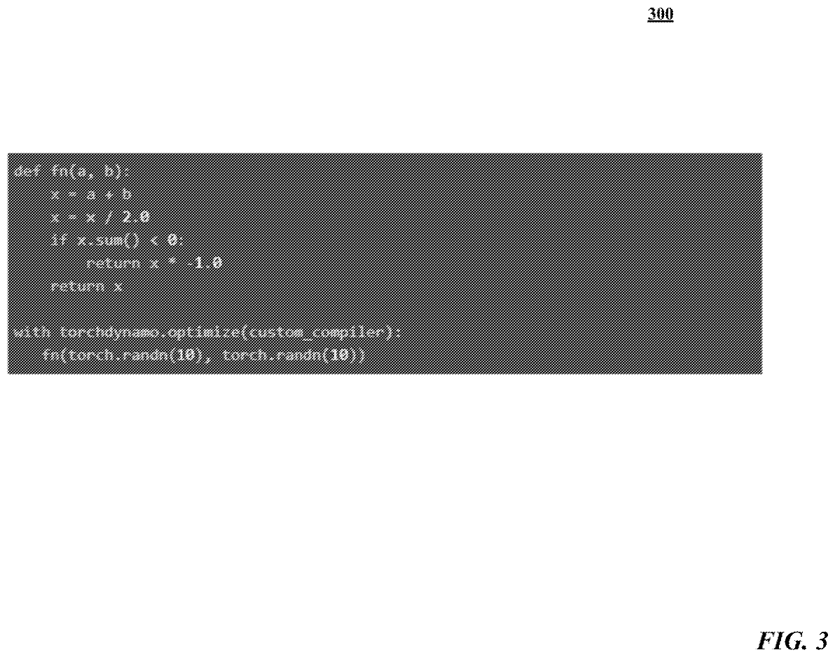

FIG. 3 illustrates example code 300. In particular embodiments, the code 300 may define a function including variables a and b. In particular embodiments, the code 300 may include one or more operations. In particular embodiments, the code 300 may include code to use a just-in-time compiler to dynamically modify the bytecode associated with the code 300 prior to executing. As an example and not by way of limitation, the code 300 may include code to use TorchDynamo to optimize the code 300.

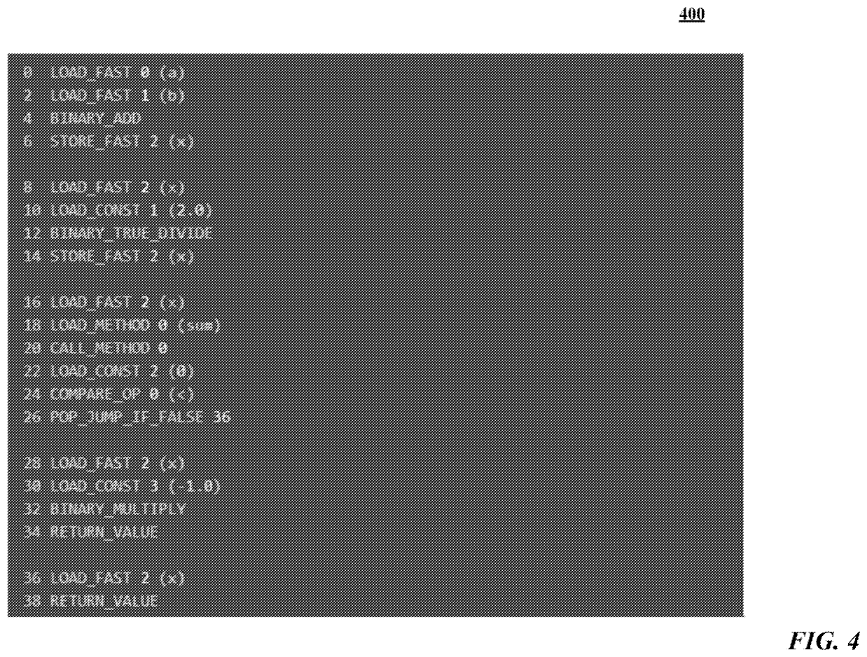

FIG. 4 illustrates example bytecode 400. In particular embodiments, the example bytecode 400 may be bytecode 400 translated from the code 300 shown in FIG. 3. In particular embodiments, the bytecode 400 may be interpreted using an interpreter to execute the bytecode 400.

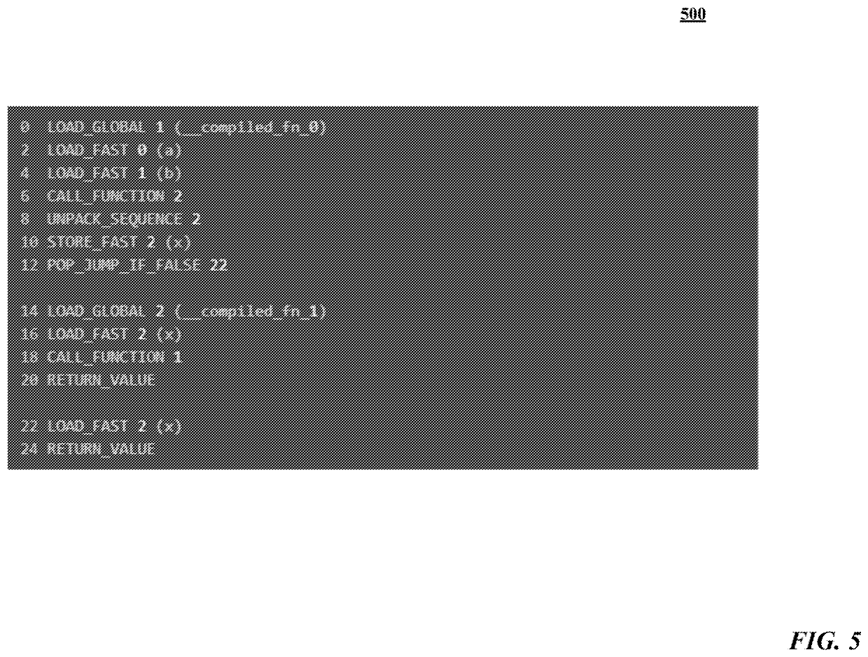

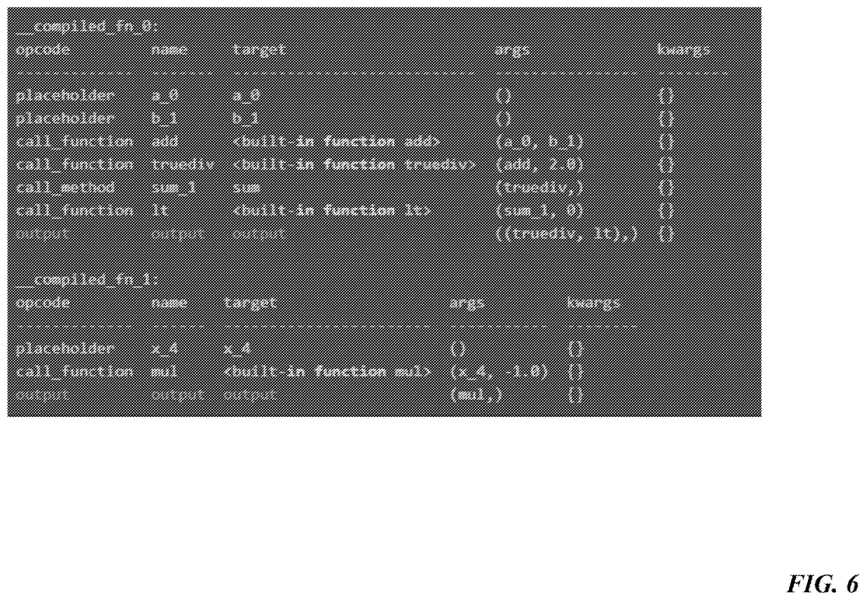

FIG. 5 illustrates another example bytecode 500. In particular embodiments, the example bytecode 500 may be bytecode 500 dynamically modified from bytecode 400. As an example and not by way of limitation, the bytecode 400 may be analyzed and dynamically modified to transform into bytecode 500. In particular embodiments, a computing system may use a just-in-time compiler to analyze the bytecode 400 to transform into bytecode 500. In particular embodiments, the just-in-time compiler may generate FX graphs that are then compiled into functions using a user-defined compiler, such as the compiled functions shown in FIG. 6. The bytecode 400 may be transformed to include calls to the compiled functions generated from the FX graphs. In particular embodiments, the compiled functions as shown in FIG. 6 may include opcodes, names, targets, args, and kwargs. In particular embodiments, the just-in-time compiler may generate one or more guards corresponding to the bytecode 500. In particular embodiments, the just-in-time compiler may leave calls to non-recognizable things or fancy structures in the original bytecode. This enables the just-in-time compiler to find opportunities for optimization without sacrificing the Python user experience. In particular embodiments, the just-in-time compiler may hook into a frame evaluation API to dynamically modify bytecode before it is being executed. As an example and not by way of limitation, TorchDynamo may hook into the frame evaluation API in CPython to dynamically modify Python bytecode before it is being executed.

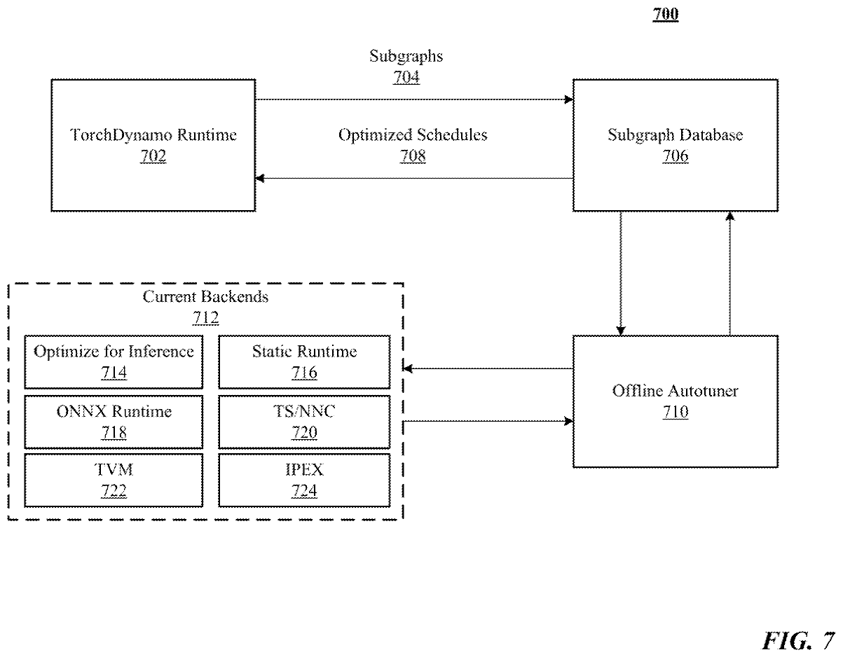

FIG. 7 illustrates an example process 700 of a just-in-time compiler operating during runtime. In particular embodiments, TorchDynamo Runtime 702 may dynamically analyze and transform bytecode. While this disclosure describes a process 700 using TorchDynamo to and the respective components to perform the process 700, this disclosure contemplates other just-in-time compilers and/or other components to perform this process 700. TorchDynamo may hook into a frame evaluation API to dynamically modify bytecode before it is executed. TorchDynamo may create FX graphs through bytecode analysis and may generate smaller graph fragments that can be mixed into execution of the code. In particular embodiments, the TorchDynamo Runtime 702 may initially generate FX graphs from the bytecode. TorchDyanmo may then hash the FX graph into a graph key. In particular embodiments, the graph key may be embodied as a subgraph 704. TorchDynamo Runtime 702 may send the one or more subgraphs 704 to a subgraph database 706. The subgraph database 706 may check to determine whether the received subgraph 704 is in the subgraph database 706. If the subgraph 704 is not in the subgraph database 706, then the subgraph 704 may be added to the subgraph database 706 and the FX graph corresponding to the subgraph 704 may be run eagerly. If the subgraph 704 is in the subgraph database 706 and has been optimized, then the subgraph database 706 may send back an optimized schedule 708. TorchDynamo Runtime 702 may use the optimized schedule 708 and a backend corresponding to the sent subgraph 704 to run execute the bytecode. In particular embodiments, the process 700 may include an optimization process using an offline autotuner 710. The offline autotuner 710 may iterate through the subgraph database 706 and optimize the graphs found there. The offline autotuner may have a plurality of backends 712. In particular embodiments, the backends 712 include one or more of an optimize for inference backend 714, a static runtime backend 716, an ONNX runtime backend 718, a TS/NNC backend 720, a TVM backend 722, and an IPEX backend 724. In particular embodimenst, the offline autotuner 710 may run each of the backends 712 select the fastest one for each subgraph. The offline autotuner 710 may perform validation and correctness checking since some backends 712 produce incorrect results or crash. In particular embodiments, shap specialization may be used by the just-in-time compiler.

In particular embodiments, the optimize for inference backend 714 may perform a set of optimization passes to optimize a model for the purposes of inference. If the model is not already frozen, optimize for inference backend 714 may invoke torch.jit.freeze automatically. In particular embodiments, static runtime backend 716 may be an optimized CPU inference runtime for PyTorch models. In particular embodiments, the ONNX runtime backend 718 may include built-in optimizations. In particular embodiments, TS/NNC backend 720 may be embodied as TorchScript which may be a way to create serializable and optimizable models from PyTorch code. In particular embodiments, TVM backend 722 may be embodied as an machine learning compiler framework for CPUs, GPUs, and machine learning accelerators. In particular embodiments, IPEX backend 724 may extend optimizations for extra performance boost on specific hardware.

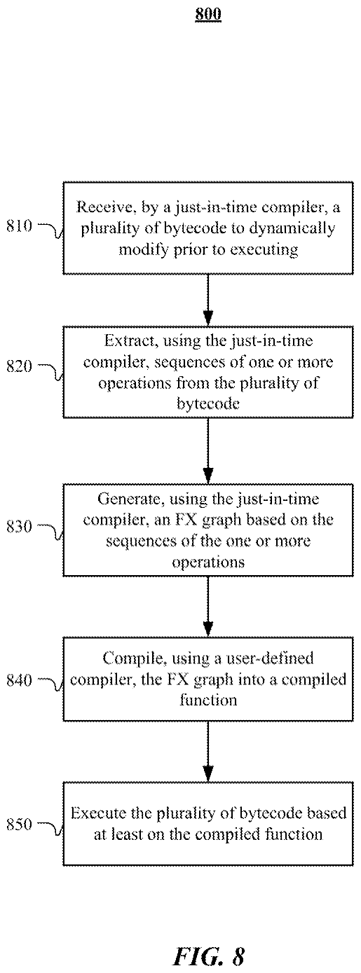

FIG. 8 illustrates an example method 800 for converting an object to bytecode. The method may begin at step 810, where a computing system may receive, by a just-in-time compiler, a plurality of bytecode to dynamically modify prior to executing. In particular embodiments, prior to the just-in-time compiler receiving the plurality of bytecode, the computing system may access an object file containing code to optimize. The computing system may use a program to translate the code to bytecode, which may be accessed by the just-in-time compiler. At step 820, the computing system may extract, using the just-in-time compiler, sequences of one or more operations from the plurality of bytecode. At step 830, the computing system may generate, using the just-in-time compiler, an FX graph based on the sequences of the one or more operations. At step 840, the computing system may compile, using a user-defined compiler, the FX graph into a compiled function. At step 850, the computing system may execute the plurality of bytecode based at least on the compiled function. In particular embodiments, the computing system may generate transformed bytecode and insert calls to the compiled functions into the transformed bytecode.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for converting an object to bytecode, including the particular steps of the method of FIG. 8, this disclosure contemplates any suitable method for converting an object to bytecode, including any suitable steps, which may include a subset of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

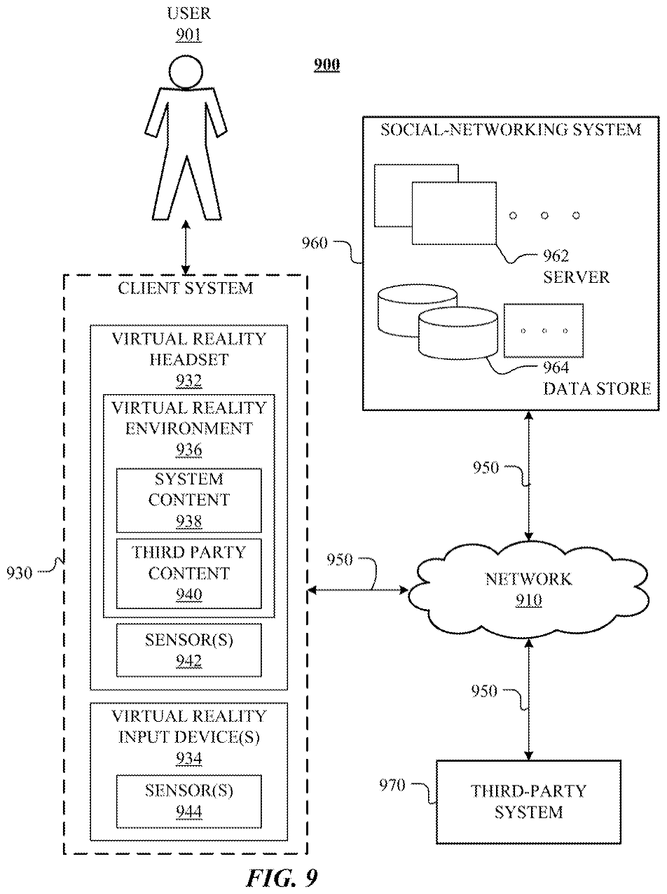

FIG. 9 illustrates an example network environment 900 associated with a virtual reality system. Network environment 900 includes a user 901 interacting with a client system 930, a social-networking system 960, and a third-party system 970 connected to each other by a network 910. Although FIG. 9 illustrates a particular arrangement of a user 901, a client system 930, a social-networking system 960, a third-party system 970, and a network 910, this disclosure contemplates any suitable arrangement of a user 901, a client system 930, a social-networking system 960, a third-party system 970, and a network 910. As an example and not by way of limitation, two or more of a user 901, a client system 930, a social-networking system 960, and a third-party system 970 may be connected to each other directly, bypassing a network 910. As another example, two or more of a client system 930, a social-networking system 960, and a third-party system 970 may be physically or logically co-located with each other in whole or in part. Moreover, although FIG. 9 illustrates a particular number of users 901, client systems 930, social-networking systems 960, third-party systems 970, and networks 910, this disclosure contemplates any suitable number of client systems 930, social-networking systems 960, third-party systems 970, and networks 910. As an example and not by way of limitation, network environment 900 may include multiple users 901, client systems 930, social-networking systems 960, third-party systems 970, and networks 910.

This disclosure contemplates any suitable network 910. As an example and not by way of limitation, one or more portions of a network 910 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 910 may include one or more networks 910.

Links 950 may connect a client system 930, a social-networking system 960, and a third-party system 970 to a communication network 910 or to each other. This disclosure contemplates any suitable links 950. In particular embodiments, one or more links 950 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 950 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 950, or a combination of two or more such links 950. Links 950 need not necessarily be the same throughout a network environment 900. One or more first links 950 may differ in one or more respects from one or more second links 950.

In particular embodiments, a client system 930 may be an electronic device including hardware, software, or embedded logic components or a combination of two or more such components and capable of carrying out the appropriate functionalities implemented or supported by a client system 930. As an example and not by way of limitation, a client system 930 may include a computer system such as a desktop computer, notebook or laptop computer, netbook, a tablet computer, e-book reader, GPS device, camera, personal digital assistant (PDA), handheld electronic device, cellular telephone, smartphone, virtual reality headset and controllers, other suitable electronic device, or any suitable combination thereof. This disclosure contemplates any suitable client systems 930. A client system 930 may enable a network user at a client system 930 to access a network 910. A client system 930 may enable its user to communicate with other users at other client systems 930. A client system 930 may generate a virtual reality environment for a user to interact with content.

In particular embodiments, a client system 930 may include a virtual reality (or augmented reality) headset 932, such as OCULUS RIFT and the like, and virtual reality input device(s) 934, such as a virtual reality controller. A user at a client system 930 may wear the virtual reality headset 932 and use the virtual reality input device(s) to interact with a virtual reality environment 936 generated by the virtual reality headset 932. Although not shown, a client system 930 may also include a separate processing computer and/or any other component of a virtual reality system. A virtual reality headset 932 may generate a virtual reality environment 936, which may include system content 938 (including but not limited to the operating system), such as software or firmware updates and also include third-party content 940, such as content from applications or dynamically downloaded from the Internet (e.g., web page content). A virtual reality headset 932 may include sensor(s) 942, such as accelerometers, gyroscopes, magnetometers to generate sensor data that tracks the location of the headset device 932. The headset 932 may also include eye trackers for tracking the position of the user's eyes or their viewing directions. The client system may use data from the sensor(s) 942 to determine velocity, orientation, and gravitation forces with respect to the headset. Virtual reality input device(s) 934 may include sensor(s) 944, such as accelerometers, gyroscopes, magnetometers, and touch sensors to generate sensor data that tracks the location of the input device 934 and the positions of the user's fingers. The client system 930 may make use of outside-in tracking, in which a tracking camera (not shown) is placed external to the virtual reality headset 932 and within the line of sight of the virtual reality headset 932. In outside-in tracking, the tracking camera may track the location of the virtual reality headset 932 (e.g., by tracking one or more infrared LED markers on the virtual reality headset 932). Alternatively or additionally, the client system 930 may make use of inside-out tracking, in which a tracking camera (not shown) may be placed on or within the virtual reality headset 932 itself. In inside-out tracking, the tracking camera may capture images around it in the real world and may use the changing perspectives of the real world to determine its own position in space.

In particular embodiments, client system 930 (e.g., an HMD) may include a passthrough engine 946 to provide the passthrough feature described herein, and may have one or more add-ons, plug-ins, or other extensions. A user at client system 930 may connect to a particular server (such as server 962, or a server associated with a third-party system 970). The server may accept the request and communicate with the client system 930.

Third-party content 940 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 930 may enter a Uniform Resource Locator (URL) or other address directing a web browser to a particular server (such as server 962, or a server associated with a third-party system 970), and the web browser may generate a Hyper Text Transfer Protocol (HTTP) request and communicate the HTTP request to server. The server may accept the HTTP request and communicate to a client system 930 one or more Hyper Text Markup Language (HTML) files responsive to the HTTP request. The client system 930 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 960 may be a network-addressable computing system that can host an online social network. The social-networking system 960 may generate, store, receive, and send social-networking data, such as, for example, user-profile data, concept-profile data, social-graph information, or other suitable data related to the online social network. The social-networking system 960 may be accessed by the other components of network environment 900 either directly or via a network 910. As an example and not by way of limitation, a client system 930 may access the social-networking system 960 using a web browser of a third-party content 940, or a native application associated with the social-networking system 960 (e.g., a mobile social-networking application, a messaging application, another suitable application, or any combination thereof) either directly or via a network 910. In particular embodiments, the social-networking system 960 may include one or more servers 962. Each server 962 may be a unitary server or a distributed server spanning multiple computers or multiple datacenters. Servers 962 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 962 may include hardware, software, or embedded logic components or a combination of two or more such components for carrying out the appropriate functionalities implemented or supported by server 962. In particular embodiments, the social-networking system 960 may include one or more data stores 964. Data stores 964 may be used to store various types of information. In particular embodiments, the information stored in data stores 964 may be organized according to specific data structures. In particular embodiments, each data store 964 may be a relational, columnar, correlation, or other suitable database. Although this disclosure describes or illustrates particular types of databases, this disclosure contemplates any suitable types of databases. Particular embodiments may provide interfaces that enable a client system 930, a social-networking system 960, or a third-party system 970 to manage, retrieve, modify, add, or delete, the information stored in data store 964.

In particular embodiments, the social-networking system 960 may store one or more social graphs in one or more data stores 964. In particular embodiments, a social graph may include multiple nodes—which may include multiple user nodes (each corresponding to a particular user) or multiple concept nodes (each corresponding to a particular concept)—and multiple edges connecting the nodes. The social-networking system 960 may provide users of the online social network the ability to communicate and interact with other users. In particular embodiments, users may join the online social network via the social-networking system 960 and then add connections (e.g., relationships) to a number of other users of the social-networking system 960 whom they want to be connected to. Herein, the term “friend” may refer to any other user of the social-networking system 960 with whom a user has formed a connection, association, or relationship via the social-networking system 960.

In particular embodiments, the social-networking system 960 may provide users with the ability to take actions on various types of items or objects, supported by the social-networking system 960. As an example and not by way of limitation, the items and objects may include groups or social networks to which users of the social-networking system 960 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 960 or by an external system of a third-party system 970, which is separate from the social-networking system 960 and coupled to the social-networking system 960 via a network 910.

In particular embodiments, the social-networking system 960 may be capable of linking a variety of entities. As an example and not by way of limitation, the social-networking system 960 may enable users to interact with each other as well as receive content from third-party systems 970 or other entities, or to allow users to interact with these entities through an application programming interfaces (API) or other communication channels.

In particular embodiments, a third-party system 970 may include one or more types of servers, one or more data stores, one or more interfaces, including but not limited to APIs, one or more web services, one or more content sources, one or more networks, or any other suitable components, e.g., that servers may communicate with. A third-party system 970 may be operated by a different entity from an entity operating the social-networking system 960. In particular embodiments, however, the social-networking system 960 and third-party systems 970 may operate in conjunction with each other to provide social-networking services to users of the social-networking system 960 or third-party systems 970. In this sense, the social-networking system 960 may provide a platform, or backbone, which other systems, such as third-party systems 970, may use to provide social-networking services and functionality to users across the Internet.

In particular embodiments, a third-party system 970 may include a third-party content object provider. A third-party content object provider may include one or more sources of content objects, which may be communicated to a client system 930. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 960 also includes user-generated content objects, which may enhance a user's interactions with the social-networking system 960. User-generated content may include anything a user can add, upload, send, or “post” to the social-networking system 960. As an example and not by way of limitation, a user communicates posts to the social-networking system 960 from a client system 930. Posts may include data such as status updates or other textual data, location information, photos, videos, links, music or other similar data or media. Content may also be added to the social-networking system 960 by a third-party through a “communication channel,” such as a newsfeed or stream.

In particular embodiments, the social-networking system 960 may include a variety of servers, sub-systems, programs, modules, logs, and data stores. In particular embodiments, the social-networking system 960 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 960 may also include suitable components such as network interfaces, security mechanisms, load balancers, failover servers, management-and-network-operations consoles, other suitable components, or any suitable combination thereof. In particular embodiments, the social-networking system 960 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 960 to one or more client systems 930 or one or more third-party systems 970 via a network 910. The web server may include a mail server or other messaging functionality for receiving and routing messages between the social-networking system 960 and one or more client systems 930. An API-request server may allow a third-party system 970 to access information from the social-networking system 960 by calling one or more APIs. An action logger may be used to receive communications from a web server about a user's actions on or off the social-networking system 960. In conjunction with the action log, a third-party-content-object log may be maintained of user exposures to third-party-content objects. A notification controller may provide information regarding content objects to a client system 930. Information may be pushed to a client system 930 as notifications, or information may be pulled from a client system 930 responsive to a request received from a client system 930. Authorization servers may be used to enforce one or more privacy settings of the users of the social-networking system 960. A privacy setting of a user determines how particular information associated with a user can be shared. The authorization server may allow users to opt in to or opt out of having their actions logged by the social-networking system 960 or shared with other systems (e.g., a third-party system 970), such as, for example, by setting appropriate privacy settings. Third-party-content-object stores may be used to store content objects received from third parties, such as a third-party system 970. Location stores may be used for storing location information received from client systems 930 associated with users. Advertisement-pricing modules may combine social information, the current time, location information, or other suitable information to provide relevant advertisements, in the form of notifications, to a user.

### Artificial Neural Networks

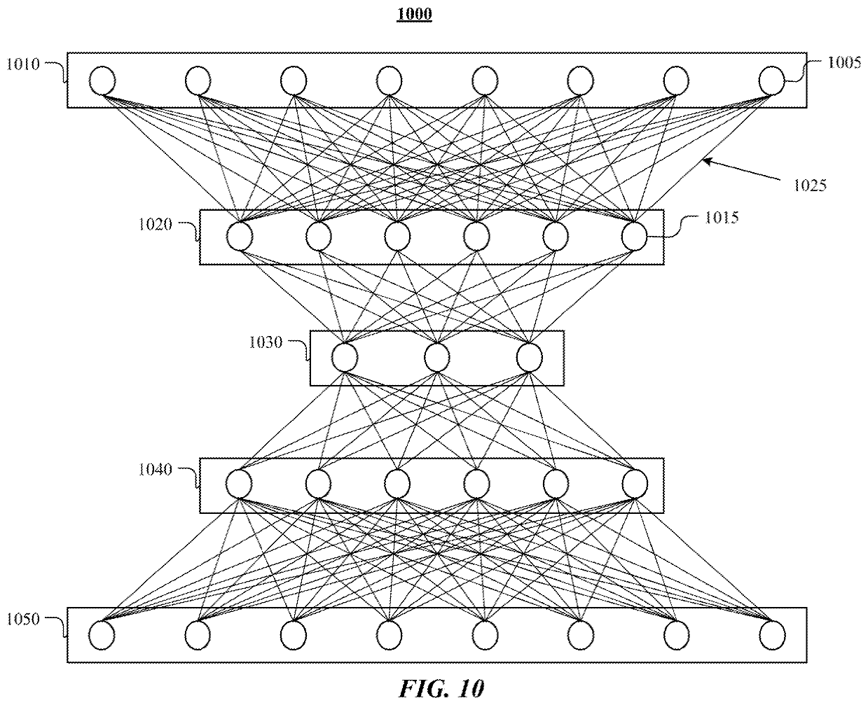

FIG. 10 illustrates an example artificial neural network (“ANN”) 1000. In particular embodiments, an ANN may refer to a computational model comprising one or more nodes. Example ANN 1000 may comprise an input layer 1010, hidden layers 1020, 1030, 1040, and an output layer 1050. Each layer of the ANN 1000 may comprise one or more nodes, such as a node 1005 or a node 1015. In particular embodiments, each node of an ANN may be connected to another node of the ANN. As an example and not by way of limitation, each node of the input layer 1010 may be connected to one of more nodes of the hidden layer 1020. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 10 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 10 depicts a connection between each node of the input layer 1010 and each node of the hidden layer 1020, one or more nodes of the input layer 1010 may not be connected to one or more nodes of the hidden layer 1020.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 1020 may comprise the output of one or more nodes of the input layer 1010. As another example and not by way of limitation, the input to each node of the output layer 1050 may comprise the output of one or more nodes of the hidden layer 1040. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(sₖ)=max (0, sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 1025 between the node 1005 and the node 1015 may have a weighting coefficient of 0.4, which may indicate that 0.4 multiplied by the output of the node 1005 is used as an input to the node 1015. As another example and not by way of limitation, the output yₖ of node k may be yₖ=Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 1000 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

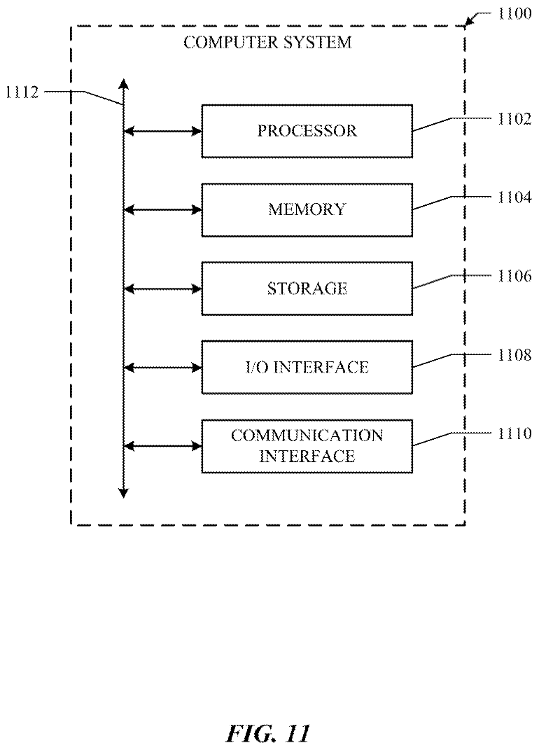

FIG. 11 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
receiving, by a just-in-time compiler, a plurality of bytecode to dynamically modify prior to executing;
extracting, using the just-in-time compiler, sequences of one or more operations from the plurality of bytecode;
generating, using the just-in-time compiler, an FX graph based on the sequences of the one or more operations;
compiling, using a user-defined compiler, the FX graph into a compiled function; and
executing the plurality of bytecode based at least on the compiled function.

2. The method of claim 1, further comprising:
analyzing, using the just-in-time compiler, the plurality of bytecode;
generating one or more small graph fragments, wherein the FX graph comprises the one or more small graph fragments.

3. The method of claim 1, further comprising:
identifying, using the just-in-time compiler, one or more calls to an unrecognizable structure from the plurality of bytecode, wherein executing the plurality of bytecode comprises at least executing the identified one or more calls.

4. The method of claim 1, further comprising:
inserting one or more calls to the compiled function into the plurality of bytecode to be executed.

5. The method of claim 1, further comprising:
generating, by the just-in-time compiler, one or more guards for the plurality of bytecode.

6. The method of claim 5, further comprising:
identifying, by the just-in-time compiler, a failure of the one or more guards for the plurality of bytecode; and
triggering, in response to the failure of the one or more guards by the just-in-time compiler, an analysis of the plurality of bytecode.

7. The method of claim 1, further comprising:
hashing the FX graph into a graph key;
accessing a subgraph database comprising a plurality of graph keys, a plurality of backends, and a plurality of schedules; and
determining whether the graph key matches one of the plurality of graph keys.

8. The method of claim 7, further comprising:
responsive to determining the graph key does not match one of the plurality of graph keys, adding the graph key to the subgraph database, wherein executing the plurality of bytecode comprises running the graph key eagerly.

9. The method of claim 7, further comprising:
responsive to determining the graph key matches one of the plurality of graph keys, identifying a respective backend of the plurality of backends corresponding to the graph key and a respective schedule of the plurality of schedules corresponding to the graph key, wherein executing the plurality of bytecode comprises using the respective backend and the respective schedule.

10. One or more computer-readable non-transitory storage media embodying software that is operable when executed to:
receive, by a just-in-time compiler, a plurality of bytecode to dynamically modify prior to executing;
extract, using the just-in-time compiler, sequences of one or more operations from the plurality of bytecode;
generate, using the just-in-time compiler, an FX graph based on the sequences of the one or more operations;
compile, using a user-defined compiler, the FX graph into a compiled function; and
execute the plurality of bytecode based at least on the compiled function.

11. The media of claim 10, wherein the one or more computer-readable non-transitory storage media is further operable when executed to:
analyze, using the just-in-time compiler, the plurality of bytecode;
generate one or more small graph fragments, wherein the FX graph comprises the one or more small graph fragments.

12. The media of claim 10, wherein the one or more computer-readable non-transitory storage media is further operable when executed to:
identify, using the just-in-time compiler, one or more calls to an unrecognizable structure from the plurality of bytecode, wherein executing the plurality of bytecode comprises at least executing the identified one or more calls.

13. The media of claim 10, wherein the one or more computer-readable non-transitory storage media is further operable when executed to:
insert one or more calls to the compiled function into the plurality of bytecode to be executed.

14. The media of claim 10, wherein the one or more computer-readable non-transitory storage media is further operable when executed to:
generate, by the just-in-time compiler, one or more guards for the plurality of bytecode.

15. The media of claim 14, wherein the one or more computer-readable non-transitory storage media is further operable when executed to:
identify, by the just-in-time compiler, a failure of the one or more guards for the plurality of bytecode; and
trigger, in response to the failure of the one or more guards by the just-in-time compiler, an analysis of the plurality of bytecode.

16. A system comprising:
one or more processors; and
one or more computer-readable non-transitory storage media coupled to one or more of the processors and comprising instructions operable when executed by one or more of the processors to cause the system to:
receive, by a just-in-time compiler, a plurality of bytecode to dynamically modify prior to executing;
extract, using the just-in-time compiler, sequences of one or more operations from the plurality of bytecode;
generate, using the just-in-time compiler, an FX graph based on the sequences of the one or more operations;
compile, using a user-defined compiler, the FX graph into a compiled function; and
execute the plurality of bytecode based at least on the compiled function.

17. The system of claim 16, wherein the one or more computer-readable non-transitory storage media is further operable when executed to:
analyze, using the just-in-time compiler, the plurality of bytecode;
generate one or more small graph fragments, wherein the FX graph comprises the one or more small graph fragments.

18. The system of claim 16, wherein the one or more computer-readable non-transitory storage media is further operable when executed to:
identify, using the just-in-time compiler, one or more calls to an unrecognizable structure from the plurality of bytecode, wherein executing the plurality of bytecode comprises at least executing the identified one or more calls.

19. The system of claim 16, wherein the one or more computer-readable non-transitory storage media is further operable when executed to:
insert one or more calls to the compiled function into the plurality of bytecode to be executed.

20. The system of claim 16, wherein the one or more computer-readable non-transitory storage media is further operable when executed to:
generate, by the just-in-time compiler, one or more guards for the plurality of bytecode.
